(19) United States
(12) Patent Application Publication
(10) Pub. No.: US 2014/0069674 A1
(43) Pub. Date: Mar. 13, 2014

(54) PERCUSSIVE HAMMER FOR PNEUMATIC OR ELECTRIC TOOLS

(71) Applicant: Rambo TSAI, Taichung City (TW)

(72) Inventor: Rambo TSAI, Taichung City (TW)

(73) Assignee: SUPER POWER TOOLS CO., LTD., Taichung City (TW)

(21) Appl. No.: 13/606,497

(22) Filed: Sep. 7, 2012

(51) Int. Cl. B25B 21/02

(52) U.S. Cl. 173/93

(57) ABSTRACT

A striking mechanism of a pneumatic tool has a drive shaft with striking rod section, a hammering frame base sleeved on the exterior of the striking rod section, two swing hammers pivoted into the hammering frame base in a staggered state, and a reversing actuator for controlling the swing hammer's swinging direction. Two striking lugs are in integrally protruded on opposite sides of the striking rod section in a staggered state. Two reinforcing lugs are integrally protruded on opposite sides of the striking rod section and integrally connected with two striking lugs, respectively, in an axial extension state along the drive shaft. Slip guide edges are formed on two opposite sides of the protruded end of each reinforcing lug, allowing override slip of the reinforcing lug and corresponding arc-shaped hammer block on the swing hammer without generating striking action.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

REFERENCE TO AN APPENDIX SUBMITTED ON COMPACT DISC

Not applicable.

### BACKGROUND OF THE INVENTION

1. Field of the Invention

The present invention relates generally to a striking mechanism of pneumatic tools, and more particularly to an innovative one which could be operated in 360° full-stroke conditions to effectively enhance its striking torsion and stress intensity of striking lugs.

2. Description of Related Art Including Information Disclosed Under 37 CFR 1.97 and 37 CFR 1.98.

Pneumatic took are structurally designed in a way that if the tool end is used to unlock and lock bolts, a striking mechanism is generally set on the output shaft end of the pneumatic tool for reinforcing its torsion and improving the capacity and effect of unlocking and locking bolts.

According to the principle and structure of said striking mechanism, forward and backward striking lugs are protruded on the main shaft, and a swinging struck block is pivoted on the frame base sleeved externally onto the main shaft. Hence, when the main shafts rotation is stopped, the frame base shall drive its struck block to hammer the striking lugs on the main shaft due to inertial rotation, then strong vibrational impact power along the rotating direction of the main shaft will be further generated, thereby increasing the capacity and effect of the main shaft to unlock and lock bolts.

The possible torsion of said striking mechanism depends on the stroke of lugs before striking, in addition to the weight and impact area between lugs. Of which, the area and weight are limited by the specifications of available pneumatic tools, so there is little space for maximization. In addition, if the torsion is increased by adding the components area and weight, the product's volume and weight will increase accordingly in a relatively imperfect solution. As for said stroke before striking, a 360° full-stroke design could multiply the torsion than 180° semi-stroke design. Yet, the following problems and shortcomings are still found with respect to the prior art with 360° full-stroke structure:

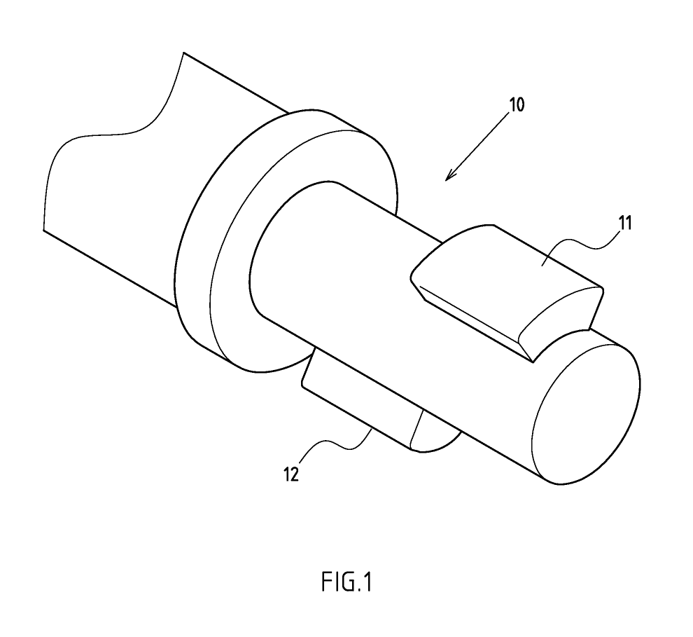

Referring to FIG. 1, if 360° pattern is introduced to the striking mechanism, a hammer lug 12 must be set axially at a staggered position on opposite sides of the preset striking section correspondingly to the main shaft 10 (omitted in drawings), thus, an expected 360° full-stroke striking pattern could be implemented by said hammer lugs. However, it is observed during actual applications that the stress intensity is only obtained from the mating portion of the hammer lugs 11,12 and main shaft 10, which is insufficient in practice. When such a full-stroke mechanism is operated, the striking force of the hammer lugs 11,12 and striking piece is doubled than conventional 180° semi-stroke one, but the mating stress intensity of hammer lugs 11,12 is not yet improved. Under the same operating frequency, a 360° full-stroke striking mechanism is vulnerable to breakage, leading to shorter service life. If a reinforced portion is extended directly on the sides of said hammer lugs 11, 12, the operating feasibility of another set of hammer lugs and striking piece will be interfered, bringing about bottleneck and dilemma to such kind of striking mechanism. Therefore, great efforts will be made in this field to develop an innovative, practical structure of great torsion and high stress intensity.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the unique structural design of the present invention wherein the striking mechanism of a pneumatic tool mainly comprises: said reinforcing lugs integrally protruded on opposite sides of the striking rod section and integrally connected with two striking lugs, respectively, in an axial extension state along the drive shaft, and slip guide edges formed on two opposite sides of the protruded end of the reinforcing lug, this allows override slip of the reinforcing lug and corresponding arc-shaped hammer block on the swing hammer without generating striking action. The striking mechanism of the pneumatic tool could be operated in 360° full-stroke, effectively enhancing the striking torsion and stress intensity of striking lug, significantly improving efficiency of the striking mechanism of pneumatic tool to meet the users requirements for durability and service life.

Moreover, based on the structural design wherein a semi-round inner groove is set on two side wall edges of the hammering frame base, and a semi-round cylindrical surface is set on the corresponding side of the pin-jointed column of the swing hammer for inserting into the semi-round inner groove, the pin-jointed column of the swing hammer could occupy less space to reduce overall material costs of the hammering frame base. Besides, the swing hammer could swing more smoothly and stably via large-area contact and mating of the semi-round cylindrical surface and semi-round inner groove.

Although the invention has been explained in relation to its preferred embodiment, it is to be understood that many other possible modifications and variations can be made without departing from the spirit and scope of the invention as hereinafter claimed.

BRIEF DESCRIPTION OF THE SEVERAL VIEWS OF THE DRAWINGS

FIG. 1 is a perspective view of a conventional structure.

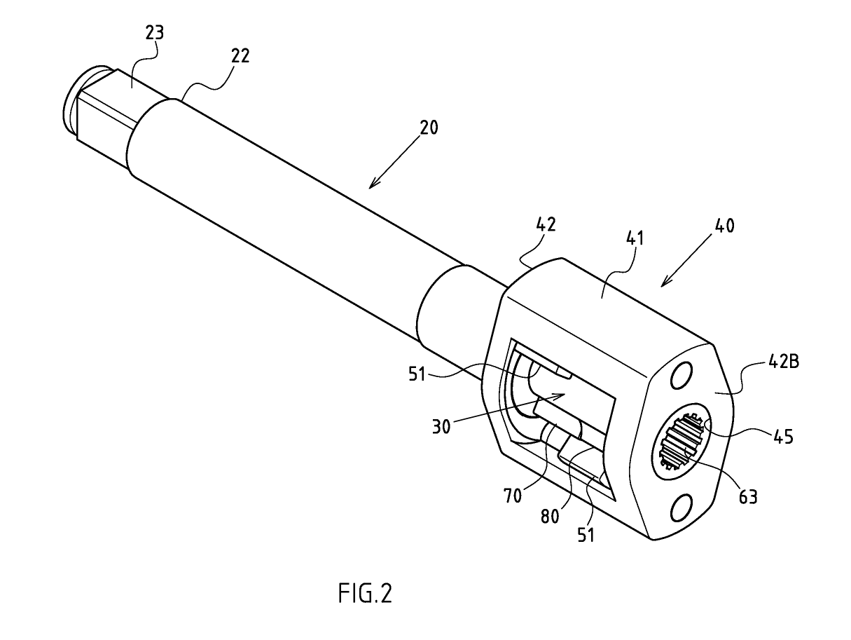

FIG. 2 is an assembled perspective view of the preferred embodiment of the present invention.

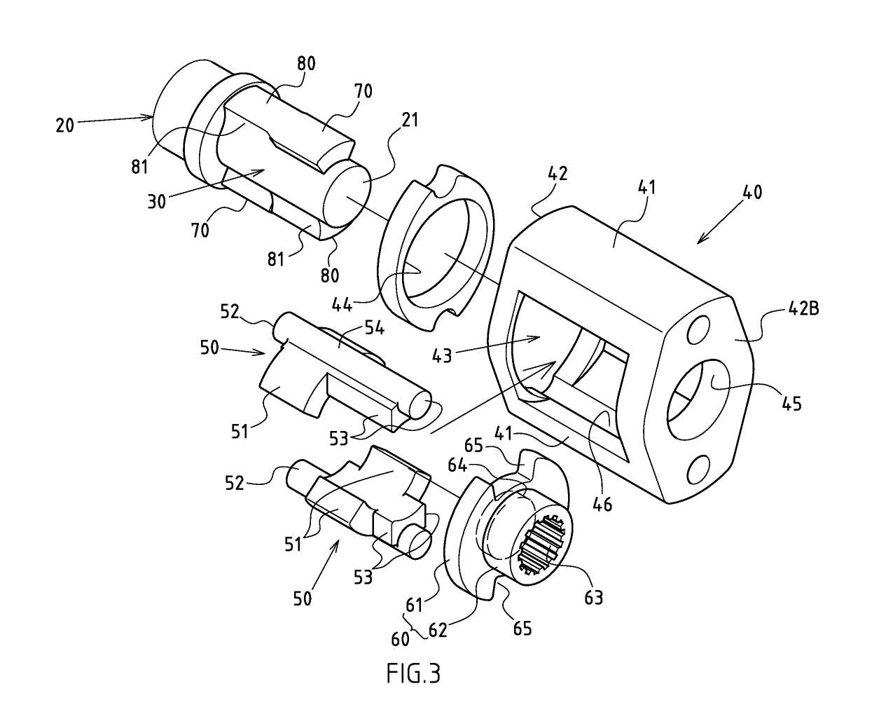

FIG. 3 is an exploded perspective view of the preferred embodiment of the present invention.

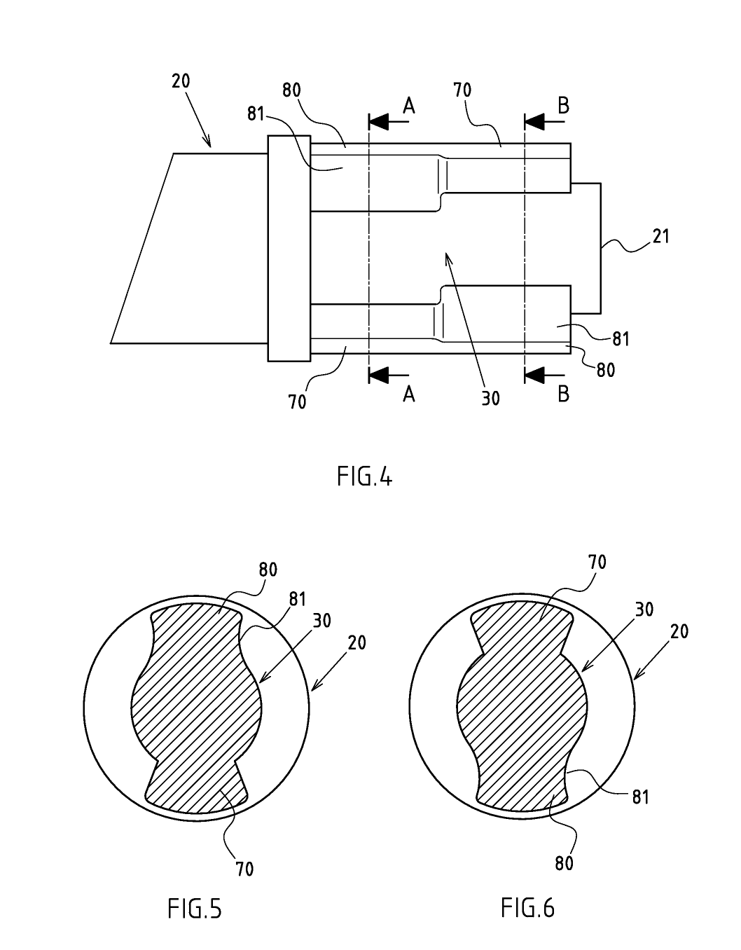

FIG. 4 is a plane lateral view of the striking rod section of the present invention.

FIG. 5 is a sectional view of A-A in FIG. 4.

FIG. 6 is a sectional view of B-B in FIG. 4.

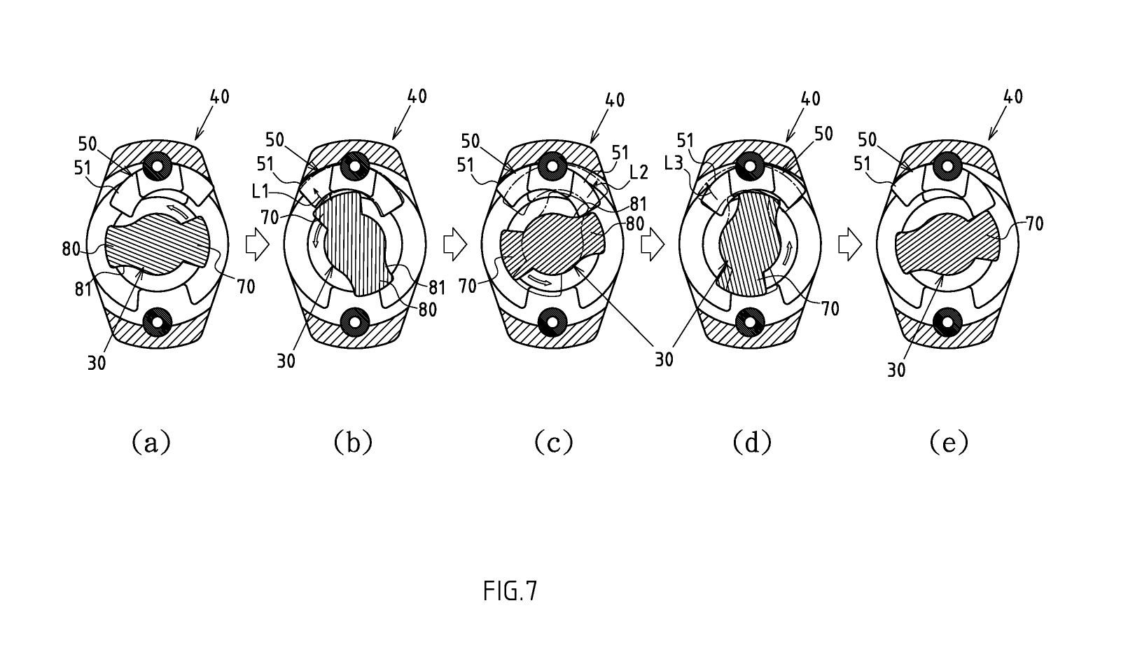

FIG. 7 is an actuating view of a 360° full-stroke condition of the striking mechanism of the present invention.

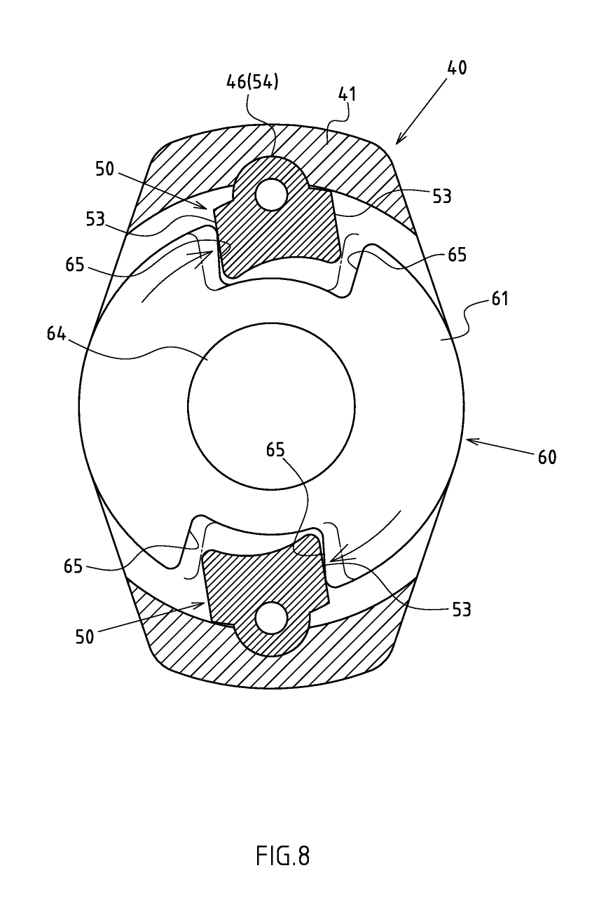

FIG. 8 is an actuating view of the present invention wherein the reversing actuator is used to shift the swinging direction of the swing hammer.

### DETAILED DESCRIPTION OF THE INVENTION

FIGS. 1-6 depict preferred embodiments of the improved striking mechanism of pneumatic tools of the present invention, which, however, are provided for only explanatory objective for patent claims.

Said pneumatic tool is a pneumatic wrench. Said striking mechanism includes a drive shaft 20, extended to define a head end 21 and a tail end 22. Of which, the tail end 22 is provided with a service portion 23, which could be designed into a corner post pattern.

A striking rod section 30 is set on the head end 21 of the drive shaft 20.

A hammering frame base 40 is movably sleeved on exterior of the striking rod section 30, and comprises of two opposite side wall edges 41, two end wall edges 42, 42B, and a holding space 43. Wherein, a through-hole 44 and a spacing end hole 45 are separately set on two end wall edges 42, 42B, allowing the head end 21 of the drive shaft 20 to penetrate the through-hole 44, so that the striking rod section 30 could be fitted into the holding space 43.

Two swing hammers 50 are pivoted into the holding space 43 in a staggered state at a spacing with the striking rod section 30. The swing hammer 50 comprises of an arc-shaped hammer block 51 and a pin-jointed column 52 provided with a pushed edge 53.

A reversing actuator 60 is provided which comprises of a disc 61 and a convex shaft portion 62 protruded from the middle of one end of the disc 61. The convex shaft portion 62 is pivoted and inserted into the spacing end hole 45 located on the end wall edge 42B of the hammering frame base 40, and an inserting groove 63 for pneumatic tools (which could be designed into a multitooth hole pattern) is set into the end surface of the convex shaft portion 62. A groove 64 is set into the middle of the other end of the disc 61 for insertion of the head end 21 of the drive shaft 20 in a pivoted state. A reversing actuating edge 65 is set on opposite sides of the disc 61 correspondingly to the pushed edge 53 on the pin-jointed column 52 of two swing hammers 50, respectively.

Two striking lugs 70 are integrally protruded on opposite sides of the striking rod section in a staggered state. These two striking lugs 70 are separately aligned with the arc-shaped hammer blocks 51 of two swing hammers 50 to generate striking action.

Two integrally extended reinforcing lugs 80 are integrally protruded on opposite sides of the striking rod section and also integrally connected with two striking lugs 70 respectively in an axial extension state along the drive shaft 20.

Slip guide edges 81 are formed on two opposite sides of the protruded end of the reinforcing lug 80, allowing override slip of the reinforcing lug 80 and corresponding arc-shaped hammer block 51 on the swing hammer 50 without generating striking action. With this design, as the reinforcing lug 80 and swing hammer 50 do not generate striking action, the striking lug 70 and corresponding arc-shaped hammer block 51 on the swing hammer 50 could reach 360° full-stroke (namely, once 360° rotation, the striking lug 70 could finish a striking action together with the arc-shaped hammer block 51), enabling greater torsional performance of the striking mechanism.

Of which, said reinforcing lug 80 has a protruding height the same as the striking lug 70 in a flushing pattern.

Of which, a semi-round inner groove 46 is set on two side wall edges 41 of the hammering frame base 40. A semi-round cylindrical surface 54 is set on the corresponding side of the pin-jointed column 52 of two swing hammers 50 for inserting into the semi-round inner groove 46.

Based on above-specified structural design, the present invention is operated as follows:

According to the combined drive mode of said striking mechanism and existing pneumatic tools (pneumatic wrench) (the same as the prior art): the inserting groove 63 for pneumatic tools on the end surface of the convex shaft portion 62 of the reversing actuator 60 is sleeved into the output shaft of the pneumatic tools. Then, the service portion 23 of the tail end 22 of the drive shaft 20 is inserted into the bolt for unlocking and locking. When the pneumatic tools rotates, the drive shaft 20 is driven synchronously, and the hammering frame base 40 also rotates along with the swing hammer 50. When the drive shaft 20 is stopped by resistance, the hammering frame base 40 will rotate continuously because of inertial rotation. In this process, a striking action will occur between the swing hammer 50 and the striking lug 70 on the striking rod section 30.

Referring to FIG. 7, the present invention of 360° full-stroke will be more readily understood with reference o the striking action of a set of swing hammer 50 and striking lug 70. For the purpose of description, the angle of hammering frame base 40 is deliberately fixed, in relation to the rotating angle of the striking rod section 30. The difference from actual rotation state of the hammering frame base 40 is hereby stated. When the arc-shaped hammer block 51 of the swing hammer 50 could provide an angle for passing of the striking lug 70 (shown in FIG. 7(a)), and when the striking lug 70 further passes the arc-shaped hammer block 51 (shown in FIG. 7(b)), the striking lug 70 will push the arc-shaped hammer block 51 to switch its swinging direction (shown by arrow L1). Referring also to FIG. 7(c), the reinforcing lug 80 with 180° spacing to the striking lug 70 will touch the arc-shaped hammer block 51. However, the arc-shaped hammer block 51 could be driven to switch again its swinging direction through the guidance of the slip guide edge 81 (shown by arrow L2), allowing override slip of the reinforcing lug 80 and corresponding arc-shaped hammer block 51 without generating striking action. Referring to FIG. 7(d), when the reinforcing lug 80 passes the arc-shaped hammer block 51, the arc-shaped hammer block 51 will switch again its swinging direction (shown by arrow L3). Then, referring to FIG. 7(e), when the striking lug 70 rotationally moves a circle of 360°, as the swinging direction of arc-shaped hammer block 51 is abutted angularly with the striking lug 70, a striking action occurs between them, thus finishing a cycle of striking action.

Referring to FIG. 8 after realizing a striking action by the arc-shaped hammer block 51 abutted with the striking lug 70, if the output shaft of the pneumatic tools is operated continuously, the reversing actuator 60 is driven to push the pushed edge 53 on the pin-jointed column 52 of two swing hammers 50 via the reversing actuating edge 65 on the disc 61, so that the swing hammer 50 along with the arc-shaped hammer block 51 switches the swinging direction, thus returning to the angular state for passing of the striking lug 70 as shown in FIG. 7(a).

Based on the core design of the present invention wherein the striking mechanism of pneumatic tool could be operated in 360° full-stroke conditions, the mating area (up to twice as the striking lug) between the striking lug 70 and striking rod section 30 could be substantially increased by the integrally extended reinforcing lug 80 with slip guide edge 81. This could effectively enhance the stress intensity of the striking lug, improving the durability and extending the service life, etc; as for the striking torsion, as the radically protruded volume of said reinforcing lug 80 is equal to the striking lug, the rotating inertia of the striking rod section 30 could be promoted to further enhance the striking torsion.

I claim:

1. A striking mechanism of pneumatic tools, which comprising:
a drive shaft, extended to define a head end and a tail end; of which, the tail end is provided with a service portion;
a striking rod section, set on the head end of the drive shaft;
a hammering frame base, movably sleeved on exterior of the striking rod section, and comprising of two opposite side wall edges, two end wall edges and a holding space; wherein, a through-hole and a spacing end hole are separately set on two end wall edges, allowing the head end of the drive shaft to penetrate the through-hole, so that the striking rod section could be fitted into the holding space;
two swing hammers, pivoted into the holding space in a staggered state at a spacing with the striking rod section; the swing hammer comprises of an arc-shaped hammer block and a pin-jointed column provided with a pushed edge;
a reversing actuator, comprising of a disc and a convex shaft portion protruded from the middle of one end of the disc; the convex shaft portion is pivoted and inserted into the spacing end hole located on the end wall edge of the hammering frame base, and an inserting groove for pneumatic tool is set into the end surface of the convex shaft portion; a groove is set into the middle of the other end of the disc for insertion of the head end of the drive shaft in a pivoted state; a reversing actuating edge is set on opposite sides of the disc correspondingly to the pushed edge on the pin-jointed column of two swing hammers, respectively;
two striking lugs, integrally protruded on opposite sides of the striking rod section in a staggered state; these two striking lugs are separately aligned with the arc-shaped hammer blocks of two swing hammers to generate striking action;
two integrally extended reinforcing lugs, integrally protruded on opposite sides of the striking rod section and integrally connected with two striking lugs respectively in an axial extension state along the drive shaft;
slip guide edges, formed on two opposite sides of the protruded end of the reinforcing Lug, allowing override slip of the reinforcing lug and corresponding arc-shaped hammer block on the swing hammer without generating striking action;
hence, said striking mechanism could be operated in 360° full-stroke condition, effectively enhancing the striking torsion and stress intensity of striking lug.

2. The structure defined in claim 1, wherein said reinforcing lug has a protruding height the same as the striking lug in a flushing pattern.

3. The structure defined in claim 1, wherein a semi-round inner groove is set on two side wall edges of the hammering frame base; and a semi-round cylindrical surface is set on the corresponding side of the pin-jointed column of two swing hammers for inserting into the semi-round inner groove.
